(19) United States
(12) Patent Application Publication
(10) Pub. No.: US 2003/0046117 A1
(43) Pub. Date: Mar. 6, 2003

(54) Display matrix for displaying rental car data

(76) Inventors: Brad Jaehn, Chicago, IL (US); Holly Bode, Chicago, IL (US)

Correspondence Address: BELL, BOYD & LLOYD, LLC, PO BOX 1135, CHICAGO, IL, 60690-1135, US

(21) Appl. No.: 09/682,448

(22) Filed: Sep. 4, 2001

(51) Int. Cl. G06F 17/60

(52) U.S. Cl. 705/5; 705/1

(57) ABSTRACT

The present invention relates to a display for presenting rental car data. The display is an interactive display that presents data in a matrix of rows and columns. Column identifiers and row identifiers are provided to indicate both a rental car company and a vehicle class with which the individual data elements are associated. Each data element represents a rate that corresponds to a type of vehicle offered by a particular rental car company. The data elements are hypertext links to at least one or more web pages that provide additional information about the particular rate represented by the data element.

### BACKGROUND OF THE INVENTION

The present invention relates in general to an interactive interface for displaying rental car data to customers. In particular, the interactive interface of the present invention enables customers to view a display and compare several rental car rates in a single display matrix.

Until recently, reservations for rental cars were typically made either in person at a rental car company's offices or at a service counter set up at an airport, over the telephone, or through a travel agent. With the advent of the internet and the proliferation of travel related internet web sites, however, more and more travelers are booking travel services, including reserving rental cars, over the internet. Today consumers may contact individual rental car companies and make reservations through their internet web pages or customers can search for the best deals from among a number of different car companies through unaffiliated internet travel web sites.

When a consumer “enters” one of these web sites, be it a general travel web site or a web site dedicated to an individual rental car company, the consumer's web browser receives data from the web server that hosts the site, and causes the appropriate web pages to be displayed on the customer's computer monitor. The consumer is requested to enter data into various fields displayed on one or more of the web pages that make up the web site. Typically, the data solicited by the web page forms the basis of a search to be performed by backend systems operated by the proprietor of the web site. Typical data requested of the customer include the location where a vehicle is to be picked up and where it is to dropped off, the dates for which the vehicle is needed, and the type of vehicle desired. The consumer may also be asked to enter personal data such as his or her name, address, credit card number and so forth.

Once the customer data, including the search criteria, have been entered by the consumer and submitted to the web site, the backend systems perform a search of one or more databases to determine rental car options that are available to meet the consumer's requirements. The results of the search are then transmitted to the consumer over the internet to be displayed by the consumer's web browser.

The manner in which the search results are displayed varies from one web site to another and is often dictated by the nature of the site. For example, the search results for a web site dedicated to a single rental car car company will be displayed differently than the search results obtained from a more general travel site that searches the availability and rates of multiple rental car companies. In the case of a web site dedicated to a single rental car company, the search criteria (i.e., the data requested from the consumer describing the consumer's requirements and preferences), may be narrowly tailored to reflect the inventory of vehicles offered by that particular rental car company such that a single detailed rental option meeting all of the specific requirements of the consumer is returned for each search. The search result may be displayed as a detailed form that includes the search criteria, a quoted rate, the make and model of the car, additional charges, optional items, terms and conditions and the like.

A problem with displaying rental car search results in this manner is that it is inflexible and does not allow for comparison. If a consumer wishes to see the price for upgrading or downgrading to a different car model an entire new search is required. The results of the new search are then displayed separately from the results of the first search, and the consumer is required to page back and forth between the two results in order to compare details. Furthermore, the consumer can only compare rates and services offered by the particular rental car company on whose site the search was performed. In order to compare rates with those offered by other rental car companies, the consumer must visit additional web sites and perform additional searches. This often requires the consumer to re-enter the same data over and over at each site.

The rental car search results displayed by travel related web sites that search the availability and rates of multiple rental car companies are generally superior to those of individual rental car companies in that they allow comparisons to be made between the rates offered by different rental car companies. However, these displays are still cumbersome to use and do not display search results in an efficient manner in which differences in rates between different rental car companies and between different car makes and models are readily apparent. Typically, a general travel related web site will display a list of search results representing the offerings of a number of different rental car companies with vehicles available meeting the consumer's requirements. Each entry in the list provides details such as the name of the rental car company, the type of car, the daily rate, available options, restrictions, and the like. A problem with this type of display, however, is that only a limited number of entries may be displayed by the consumer's web browser at one time. In order to view all options and compare rates, a consumer must scroll through the list, individually noting the name of the rental car company, the price, and other data, for each entry. Again, this makes it more difficult to compare prices, and reduces the consumer's overall satisfaction with the web site.

In light of the problems with existing displays and methods for displaying rental car search results, a need exists for an improved display and method of displaying rental car search results. In such an improved display and method of displaying rental car search results, substantially all search results meeting a consumer's requirements would be displayed simultaneously on a single screen, allowing easy comparison of rates between different rental car companies and among different classes of vehicles. Preferably, data corresponding to the identification of each rental car company, the various categories of vehicles for which search results were obtained, and the corresponding rates are displayed so that a consumer can easily determine whether or not various rates offered by different rental car companies relate to comparable vehicles. By providing a display with rental car search results displayed in such a manner, a consumer may review search results more efficiently in order to make an informed choice when booking a rental car reservation.

### SUMMARY OF THE INVENTION

The present invention relates to an improved display for presenting information related to renting a vehicle from a rental car company. The invention also relates to an improved method for displaying rental car rate information. According to the invention, rental car data are displayed in a matrix format that allows a customer to easily compare and contrast several different rental car options from among different classes of vehicles, and from among a number of different rental car companies. The rental car data display and display method are particularly well adapted to be used in conjunction with a computer network browser for displaying the rental car data on the monitor of a personal computer.

According to an embodiment of the invention, a rental car display matrix is provided wherein several individual data elements are arranged in rows and columns. Data elements that are related are grouped together in the same rows and columns. Depending on the orientation of the matrix, individual columns are associated with different rental car companies and individual rows are associated with different classes of vehicles, or vice versa. It is generally preferred, however, that the data grouped together in the same columns are related to the same rental car company and that the data grouped together in the same row are related to the same class of vehicles. Depending on the orientation, a rental car company identifier is located at the head of each row or each column to identify the rental car company with which the corresponding row or column of data is associated. Similarly, a vehicle class identifier is located at the head of each of the other of said rows or columns to identify the class of vehicle with which corresponding column or row of data is associated. The company identifiers may be graphical icons, text, or a combination of a graphical icons and text with optional additional mouse-over descriptive text which appears when a computer mouse is pointed at the company identifier. Each data element displayed in the matrix provides rate information related to the price charged by the corresponding rental car company for renting a vehicle in the corresponding class. In a preferred embodiment, the data elements represent the lowest prices from a collection of prices that may be available for specific types of cars and/or classes of vehicles offered by the various rental car companies.

In an embodiment, the invention may provide an interactive display wherein the rental car data are displayed on a computer monitor using a network browser. Again, data elements are displayed in a matrix of columns and rows, with each of the columns or each of the rows representing rental car offerings provided by individual rental car companies, and the others of the columns or rows representing the classes of vehicles for which rental car data are desired. The number columns or rows displayed corresponds to the number of rental car companies having product offerings in at least one of the vehicle classes to be displayed. Company identifiers are displayed associated with each of the columns or each of the rows depending on the orientation of the matrix. Vehicle class identifiers are similarly displayed associated with each of the other of the columns or rows. Individual data elements representing rental car rates offered by the various rental car companies for vehicles in the various vehicle classes are arranged at the intersections of the columns and rows. According to this embodiment, the data elements are displayed as hypertext links to additional network display pages. By executing the links, additional information providing a more detailed description of the rate and the vehicle associated with a particular data element may be displayed.

In another aspect the invention provides a method of displaying rental car data. The first step of the method of displaying rental car data involves identifying various classes of vehicles for which data are to be displayed. The method further involves identifying rental car companies which offer vehicles, or have vehicles available in at least one of the identified classes. Once this information has been gathered, company identifiers are displayed along a first axis. Each company identifier identifies one of the identified rental car companies. Similarly, vehicle class identifiers are displayed along a second axis. Each vehicle class identifier identifies one of the identified vehicle classes. Finally, the last step involves displaying data elements in a matrix of rows and columns. Depending on the desired orientation of the display, each individual row of data elements is associated with either the company identified by the corresponding company identifier or the vehicle class identified by the corresponding vehicle class identifier. Similarly, each individual column of data is associated with either the company or the vehicle class identified by the corresponding company or vehicle class identifier.

The display provided by the present invention allows a large amount of data to be displayed together on a single screen. The data are arranged in a manner such that comparisons are easily made between the rates charged by different rental car companies and the rate available for different classes of vehicles. Thus, a consumer may efficiently browse rates and make an informed selection based on the best rates available that meet his or her requirements. Additional features and advantages of the present invention are described in, and will be apparent from, the following Detailed Description of the Invention and the Drawings.

### BRIEF DESCRIPTION OF THE DRAWINGS

FIG. 1 is a schematic representation of a rental car data display matrix according to the present invention displayed on a display device.

FIG. 2 is a display matrix according to the present invention displaying search results for a hypothetical rental car search.

FIG. 3 is a detailed information web page accessed by activating a hypertext link data element from the display matrix of FIG. 2.

FIG. 4 is a flow chart of a method for displaying rental car data according to the present invention.

### DETAILED DESCRIPTION OF THE INVENTION

The present invention relates to an interactive interface for displaying rental car data to a customer based on customer defined criteria, and a method for displaying rental car data in an efficient manner. The display organizes and displays data results in a single matrix that enables a customer to efficiently compare rental car rates and select a car and a rate that best meets his or her requirements. According to an embodiment of the invention a customer may review additional details pertaining to each result and reserve a car based on a selected result.

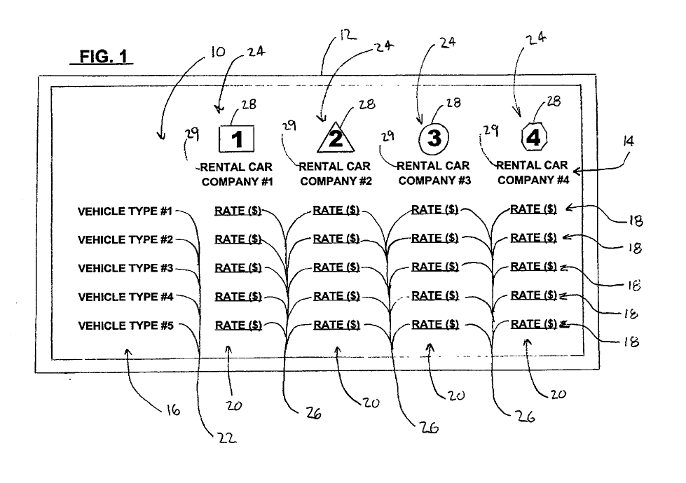

An embodiment of a rental car display matrix 10 according to the present invention is shown in FIG. 1. The rental car display matrix 10 is displayed on a monitor 12 of a personal computer. It should be noted, however, that the rental car data display matrix 10 may be displayed on any type of display device such as the LCD display of a handheld personal digital assistant, a video monitor, or other device. The rental car data display matrix 10 is defined by a horizontal axis 14, and a vertical axis 16. A plurality of data elements 26 are arranged within the matrix in horizontal rows 18 and vertical columns 20.

Each individual column of data is identified by a column heading 24, and each horizontal row is identified by a row heading 22. The number of rows and columns displayed in a display matrix 10 will depend on the search results obtained from the customer defined search criteria and the customers output device. Each row 18 represents a particular class of vehicle or vehicles with particular characteristics. Each column 20 represents the offerings of an individual rental car company. In an embodiment of the invention the column headings may be provided in the form of graphical icons 28 such as the trademarks or other brand identifiers of the various rental car companies whose rates are being displayed. Text 29, or other identifiers may also be used to identify the rental car companies represented by each column. The row headings will generally be brief text descriptions or icons representing the class of vehicles or special options available in vehicles represented by each row.

For example, if a search is performed for only a single class of vehicle, then only a single row of data having a single row heading describing the vehicle class searched will be displayed. On the other hand, if a search is performed for multiple classes of vehicles, then multiple rows with multiple row headings describing each vehicle class will be displayed. Likewise, if, after performing a search, it is determined that only a single rental car company has inventory and facilities available to meet the customer's requirements, then only a single column will be displayed. Conversely, if a number of rental car companies are available to meet the customer's requirements, then an equal number of columns will be displayed.

The data elements 18 displayed in the display matrix 10 represent the rates offered by the various rental car companies for the various classes of vehicles for which the corresponding search was performed. Preferably, the rate data displayed relate to the lowest prices available for specific types of cars or classes of vehicles offered by the various rental car companies. The rate data may be displayed on a per day basis, a per week basis, or on a total fee basis based on the dates and times for which the customer is requesting a vehicle, or some other basis. Generally, the format of the rate data will be determined by an availability search code of the host system. Regardless of the format chosen for displaying the fares, it is important that the rate displayed for each data element 18 is calculated in the same manner, i.e., returned by the same search and/or booking system and displayed on the same basis, so that a comparison of the different rates among different rental car companies and between different classes of vehicles will be meaningful.

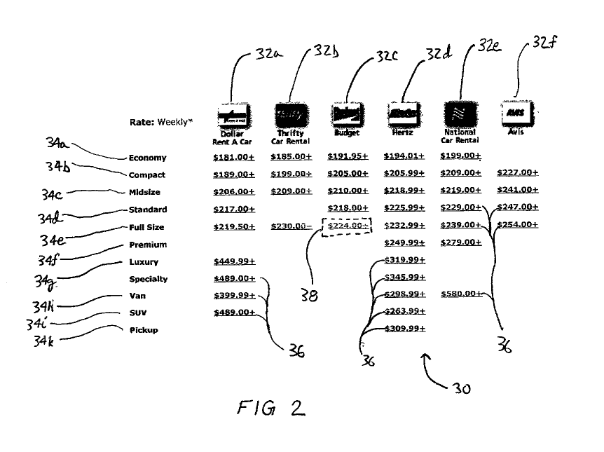

FIG. 2 shows a rental car display matrix 30 according to the present invention displaying the search results for a hypothetical customer search. The search criteria for the hypothetical search included a pickup and drop off location at or near the Peoria Airport. The car was to be picked up on August 2 at 9:00 A.M. and returned at 9:00 A.M., August 9. The search was to be conducted over all vehicle types having an automatic transmission and air conditioning. There were to be no preferences between rental car companies.

The display matrix 30 displaying the results includes column headings 32a, 32b, 32c, 32d, 32e, 32f along the top horizontal axis of the display. The column headings identify the rental car companies determined by the search to have facilities and vehicles available at or near the Peoria airport for the dates specified in the search. As can be seen, the column headings 32a-32f are a combination of a recognizable graphical icons identifying each rental car company, and the name of each rental car company written in plain text. Row headings 34a-34k are located along the left vertical axis. The row headings are merely one word textual descriptions of each vehicle class searched, although icons or other descriptors may also be provided. In the present example all vehicle types were searched and results were located for nine classes of vehicles, all of which are displayed. Of course, it is possible to classify vehicles differently than as shown. If a different classification scheme is selected, more or less rows may be required and the row headings may be changed.

As described earlier, data elements 36 are arranged in a matrix. The data elements 36 represent the rates the various rental car companies charge for the various vehicle classes. In the example shown, the rates are displayed in U.S. dollars, although other currencies may be displayed depending on the location where the car is to be picked up and dropped off, or the nationality of the customer performing the search. All of the rates offered by a given rental car company are arranged in columns, with the vertical position of a specific rate corresponding to the row associated with the class of vehicle for which the rate applies. Thus, the rates charged by each rental car company for a given class of vehicle are all found in the same row of the display matrix 30. Similarly, the rates charged by a specific rental car company for different classes of vehicles can all be found in the same column.

When viewing the data displayed in display matrix 30, it is a simple matter to quickly determine which rental car company offers the best price for each class of vehicle. All that is required is to locate the row associated with the desired class and scan horizontally across the row to find the lowest rate. Once the lowest rate has been found, scanning upward to the column heading at the top of the column in which the lowest rate appears identifies the rental car company offering the best rate for that particular class of vehicle. For example, to determine the best rate on a full sized car using display matrix 30, one must locate the full size row heading 34e and scan the data entries along that row. In this case, the entries are $219.50; $230.00; $224.00; $232.99; $239.00; and $254.00. Clearly, the $219.50 rate in the first column is the lowest. Looking to the top of the first column, column heading 32a identifies Company A as the company offering the $219.50 rate for a full size car. The same procedure may be employed to determine which company offers the best rate on a sport utility vehicle (SUV). After locating the SUV row 34j the customer determines there are only two data entries for SUVs. Thus, only two companies offer SUVs in Peoria, namely Company A and Company D, which are identified by the column headings 32a, 32d at the tops of the columns containing the two entries. The lower entry, that found in the fourth column, is associated with Company D. Where companies do not have offerings in a particular vehicle class, the corresponding row in the column is left blank. Alternatively, some other indication may be provided, such as displaying “not available” or some other message in the corresponding row/column position.

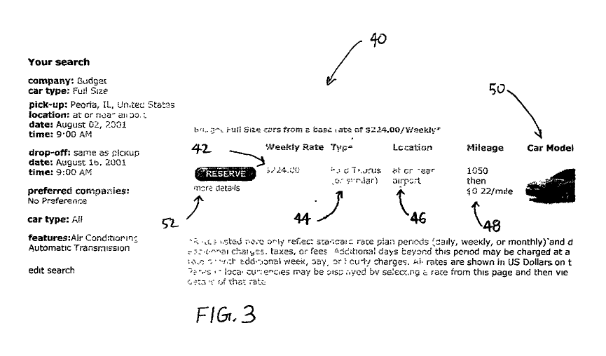

In an embodiment of the invention, the data elements 36, namely the rates listed in the various rows and columns of the display matrix are created as hypertext links to other internet web pages which provide additional detailed information regarding the rental packages represented by the data elements displayed in the display matrix. An example of a detailed information page that is displayed after selecting the hypertext link associated with data element 38 is shown in FIG. 3. The detailed information page 40 includes the rate 42, the type of car 44, the pickup/return location 46, allowed mileage and charge for over mileage 48, and a picture of the car 50. Of course other data could be displayed if desired. The detailed information page further includes a hypertext link 52 to an additional information page, and a hypertext link 54 to a reservation page for booking a reservation.

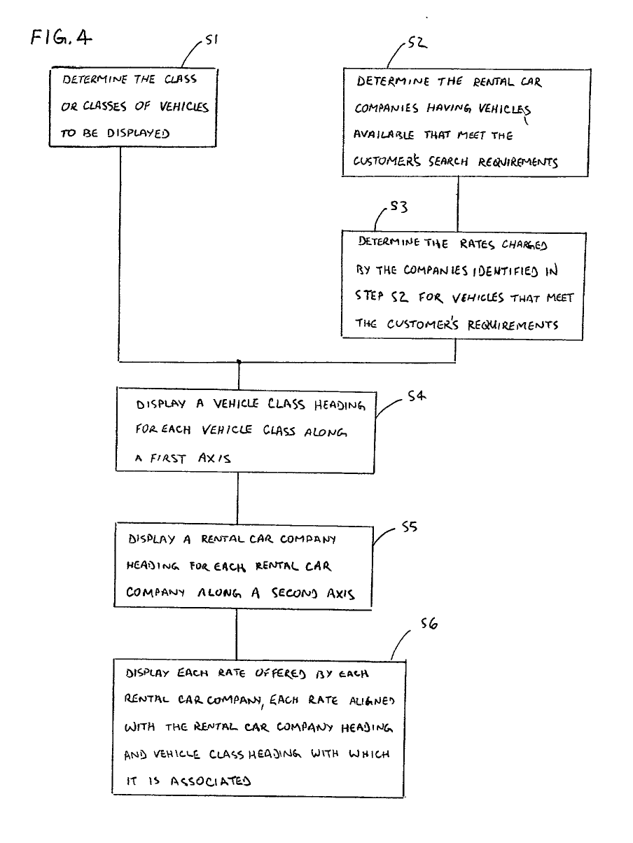

The present invention further encompasses a method for displaying rental car availability and rate data. A flow chart detailing the method is shown in FIG. 4. Steps S1-S2 and steps S3-S5 of the inventive method may be carried out substantially simultaneously or they may be carried out sequentially. In step S1, the class or classes of vehicles for which data are to be displayed are identified. In step S2, a heading is displayed for each class of vehicle identified in step S1. The vehicle class headings are displayed along a first axis. In step S3, rental car companies having vehicles available meeting a customer's search requirements are identified. Then, in step S4 the rates offered by the rental car companies identified in step S3 are identified for the various classes of vehicles identified. In step S5, headings identifying the rental car companies identified in step S3 are displayed along a second axis. Finally, in step S6, the rate data are displayed in matrix form. Individual data elements are aligned with the various vehicle class headings and rental car company headings with which they are associated. Thus, a rental car display matrix is created from which the lowest rates available for different classes of vehicles can be easily determined, as can the identity of the rental car company offering the lowest rates for the various classes of vehicles.

When the method of the present invention is practiced on an internet web browser for displaying rental car rate data on a computer screen, the step of displaying each available rate may include displaying the rate as a hypertext link to another web page. The web page addressed by the rate data hypertext link may be a page for giving additional details on the rental package offered by the rental car company or the addressed page may be a reservation page where the customer secures a reservation for the selected class of vehicle at the displayed rate.

From the above description it should be clear that the rental car display and method of displaying rental car data of the present invention provide and create a display in which a large amount of data is organized and presented in an efficient manner. Comparisons between the rates offered by different rental car companies are easily drawn, as are comparisons between the cost of renting different classes of vehicles. Further, rate data are presented in a manner in which additional information regarding specific rate data is easily accessible.

While the present invention is described in connection with what is presently considered to be the most practical and preferred embodiments, it should be appreciated that the invention is not limited to the disclosed embodiments, and is intended to cover various modifications and equivalent arrangements included within the spirit and scope of the claims. Modifications and variations in the present invention may be made without departing from the novel aspects of the invention as defined in the claims, and this application is limited only by the scope of the claims.

1. A rental car display matrix comprising:
a plurality of data elements arranged in a plurality of rows and columns, wherein data elements located together in a particular one of said rows or said columns are associated with a particular rental car company, and data elements located together in a particular one of the other of said rows or said columns are associated with a particular class of vehicle;
a rental car company identifier located at the head of each of said rows or said columns identifying the rental car company with which the data elements located in each said row or column are associated; and
a vehicle class identifier located at the head of each of the other of said rows or columns identifying the class of vehicle with which the data elements located in each said other of said rows or columns are associated.

2. The rental car display matrix of claim 1 wherein said data elements comprise rate information relating to a price offered by the associated rental car company for renting a vehicle belonging to the associated vehicle class.

3. The rental car display matrix of claim 2 wherein the price comprising the rate information represents a lowest price from among a plurality of prices for a specific type of car or class of vehicle.

4. The rental car display matrix of claim 2 wherein rental car company identifiers and said vehicle class identifiers are positioned such that the data element representing the lowest rate is located in the upper left position of the matrix.

5. The rental car display matrix of claim 2 wherein the display is adapted to be displayed by a network web browser on a computer monitor, and wherein said data elements are displayed as hypertext links to additional network web pages for providing additional information regarding the rate offered by the associated rental car company and the vehicle offered within the associated vehicle class.

6. The rental car display matrix of claim 1 wherein the rental car company identifiers comprise graphical icons including a trademark of the rental car company associated with each rental car company identifier.

7. The rental car display matrix of claim 1 wherein the rental car company identifiers include text naming the rental car company associated with each rental car company identifier.

8. The rental car display matrix of claim 1 wherein the rental car company identifiers comprise a combination of text naming the rental car company and a graphical identifier.

9. The rental car display matrix of claim 1 wherein data elements located in the same column are associated with a particular rental car company.

10. The rental car display matrix of claim 1 wherein data elements located in the same row are associated with a particular rental car company.

11. A display matrix for presenting rental car information, the matrix comprising:
a column associated with a particular rental car company;
a row associated with a particular class of vehicles;
a column heading identifying the particular rental car company with which the column is associated, and a row heading identifying the class of vehicles with which the row is associated; and
a data element displayed at the intersection of the row and the column, wherein the data element is associated with the rental car company identified in the column heading and relates to the class of vehicles identified in the row heading.

12. The display matrix of claim 11 further comprising a plurality of said rows and columns and a plurality of data elements located at the intersections of said rows and columns, the number of rows being equal to a number of vehicle classes to be displayed and each row representing a single vehicle class, and the number of columns being equal to a number of rental car companies having vehicles available in the one or more vehicle classes being displayed, with each column being associated with a particular rental car company.

13. The rental car display matrix of claim 12 wherein each data element comprises rate information relating to renting a vehicle in the associated vehicle class from the associated rental car company.

14. The rental car display matrix of claim 13 wherein the display is adapted to be displayed by a network web browser on a computer monitor, and wherein said data elements are displayed as hypertext links to additional network web pages for providing additional information regarding the rate offered by the associated rental car company, and the vehicle offered within the associated vehicle class.

15. The rental car display matrix of claim 13 wherein the column headings comprise graphical icons representing the rental car companies with which the columns are associated.

16. The rental car display matrix of claim 13 wherein the column headings include text naming the rental car companies with which the columns are associated.

17. The rental car display matrix of claim 13 wherein the column headings comprise a combination of text and a graphical identifier.

18. A display matrix for presenting rental car information, the matrix comprising:
a row associated with a particular rental car company;
a column associated with a particular class of vehicles;
a row heading identifying the particular rental car company with which the row is associated, and a column heading identifying the class of vehicles with which the column is associated; and
a data element displayed at the intersection of the column and the row, wherein the data element is associated with the rental car company identified in the row heading and relates to the class of vehicles identified in the column heading.

19. The display matrix of claim 18 further comprising a plurality of said rows and columns and a plurality of data elements located at the intersections of said rows and columns, the number of columns being equal to a number of vehicle classes to be displayed, with each column representing a single vehicle class, and the number of rows being equal to a number of rental car companies having vehicles available in the one or more vehicle classes being displayed, with each row being associated with a particular rental car company.

20. The rental car display matrix of claim 19 wherein each data element comprises rate information relating to renting a vehicle in the associated vehicle class from the associated rental car company.

21. The rental car display matrix of claim 20 wherein the display is adapted to be displayed by a network web browser on a computer monitor, and wherein said data elements are displayed as hypertext links to additional network web pages for providing additional information regarding the rate offered by the associated rental car company and the vehicle offered within the associated vehicle class.

22. The rental car display matrix of claim 20 wherein the row headings comprise graphical icons representing the rental car companies with which the rows are associated.

23. The rental car display matrix of claim 20 wherein the row headings include text naming the rental car companies with which the columns are associated.

24. The rental car display matrix of claim 20 wherein the row headings comprise a combination of text and a graphical identifier.

25. An interactive display for displaying rental car data on a computer monitor using a network browser, the interactive display comprising:
a matrix of columns and rows, each of said columns or each of said rows representing rental car offerings provided by a particular rental car company, and each of the other of said columns or rows representing a class of vehicles for which rental car data are desired, the number of said columns or rows representing individual rental car companies corresponding to the number of rental car companies offering vehicles in at least one of the vehicle classes represented by the other of said columns or rows;
a company identifier associated with each of said columns or each of said rows for identifying the particular rental car company with which the corresponding column or row is associated;
a vehicle class identifier associated with each of the other of said columns or rows for identifying the classes of vehicles with which the corresponding column or row is associated;
data elements arranged at the intersections of said columns and rows, each data element representing a rate offered by a particular rental car company for a particular class of vehicle, and wherein the data elements comprise hypertext links to additional network display pages providing additional details regarding the offerings represented by the data elements.

26. The rental car display matrix of claim 25 wherein the company identifiers comprise graphical icons.

27. The rental car display matrix of claim 25 wherein the company identifiers include text naming the rental car companies with which the corresponding column or row is associated.

28. The rental car display matrix of claim 25 wherein the company identifiers comprise a combination of text and a graphical identifier.

29. The rental car display matrix of claim 28 wherein data elements located in the same column are associated with a particular rental car company.

30. The rental car display matrix of claim 29 wherein company identifiers and said vehicle class identifiers are positioned such that the data element representing the lowest rate is located in the upper left position of the matrix.

31. A method of displaying rental car data comprising the steps of:
identifying a number of vehicle classes for which data are to be displayed;
identifying a number of rental car companies, each offering vehicles in at least one of said identified classes;
displaying company identifiers along a first axis, each company identifier identifying one of the identified rental car companies;
displaying vehicle class identifiers along a second axis, each vehicle class identifier identifying one of the identified vehicle classes; and
displaying data elements in a matrix of rows and columns the rows being associated with either the company identifiers or the vehicle class identifiers, and the columns being associated with the other said company identifiers of class identifiers such that each data element is associated with an identified rental car company and a vehicle class.

32. The method of claim 31 wherein the step of displaying data elements comprises displaying a rate for renting a vehicle in the associated vehicle class from the associated rental car company.

33. The method of claim 32 wherein the step of displaying data elements further comprises displaying the rate as a hypertext link to a detail web page to be displayed by a network web browser on a computer monitor.
